(19) United States
(12) Patent Application Publication
(10) Pub. No.: US 2026/0211846 A1
(43) Pub. Date: Jul. 23, 2026

(54) FEDERATED SYSTEM FOR LOG FILE SEARCHING

(71) Applicant: Capital One Services, LLC, McLean, VA (US)

(72) Inventors: Jayanna Chandrashekar HALLUR, Henrico, VA (US); Ranga DURISETI, Fairfax, VA (US); Yasaswy Rajendraprasad RAVALA, Richmond, VA (US); Aalishaben TORANIA, Henrico, VA (US); Himanshu MEEL, Charlotte, NC (US)

(21) Appl. No.: 19/027,384

(22) Filed: Jan. 17, 2025

(51) Int. Cl. G06F 16/14; G06F 16/11

(52) U.S. Cl. CPC G06F 16/148; G06F 16/116; G06F 16/144

(57) ABSTRACT

In some implementations, a search system may receive, from a first user device, a first search. The search system may convert the first search into a first query. The search system may return, to the first user device and from an application layer of the search system, one or more first matching log files, from the plurality of standardized log files, using the first query.

The search system may receive, from a second user device, a second search. The search system may convert the second search into a second query. The search system may return, to the second user device and from an enterprise layer of the search system, one or more second matching log files, from the plurality of standardized log files, using the second query.

### BACKGROUND

Log files for a large computerized system may be generated by different platforms and in different formats. For example, Splunk® may collect log data and store the log data in a proprietary format and in a separate storage from other log data. Searching across multiple platforms and formats for log files is computationally intensive.

### SUMMARY

Some implementations described herein relate to a system for providing federated searching. The system may include one or more memories and one or more processors communicatively coupled to the one or more memories. The one or more processors may be configured to receive, from a plurality of data sources, a plurality of log files, wherein the plurality of log files use at least two different formats. The one or more processors may be configured to convert the plurality of log files into a plurality of standardized log files, wherein the plurality of standardized log files use a unified format. The one or more processors may be configured to receive a first search. The one or more processors may be configured to convert the first search into a first query. The one or more processors may be configured to retrieve, at an application layer, one or more first matching log files, from the plurality of standardized log files, using the first query. The one or more processors may be configured to receive a second search. The one or more processors may be configured to convert the second search into a second query. The one or more processors may be configured to retrieve, at an enterprise layer, one or more second matching log files, from the plurality of standardized log files, using the second query.

Some implementations described herein relate to a method of providing federated searching of a plurality of standardized log files. The method may include receiving, from a first user device and at a search system, a first search. The method may include converting, by the search system, the first search into a first query. The method may include returning, to the first user device and from an application layer of the search system, one or more first matching log files, from the plurality of standardized log files, using the first query. The method may include receiving, from a second user device and at the search system, a second search. The method may include converting, by the search system, the second search into a second query. The method may include returning, to the second user device and from an enterprise layer of the search system, one or more second matching log files, from the plurality of standardized log files, using the second query.

Some implementations described herein relate to a non-transitory computer-readable medium that stores a set of instructions for providing federated searching of a plurality of standardized log files. The set of instructions, when executed by one or more processors of a device, may cause the device to receive a first search. The set of instructions, when executed by one or more processors of the device, may cause the device to convert, using a metadata storage associated with the plurality of standardized log files, the first search into a first query. The set of instructions, when executed by one or more processors of the device, may cause the device to retrieve, at an application layer, one or more first matching log files, from the plurality of standardized log files, using the first query. The set of instructions, when executed by one or more processors of the device, may cause the device to receive a second search. The set of instructions, when executed by one or more processors of the device, may cause the device to convert, using the metadata storage, the second search into a second query. The set of instructions, when executed by one or more processors of the device, may cause the device to retrieve, at an enterprise layer, one or more second matching log files, from the plurality of standardized log files, using the second query.

### BRIEF DESCRIPTION OF THE DRAWINGS

FIGS. 1A-1G are diagrams of an example implementation relating to a federated system for log file searching, in accordance with some embodiments of the present disclosure.

FIG. 2 is a diagram of an example environment in which systems and/or methods described herein may be implemented, in accordance with some embodiments of the present disclosure.

FIG. 3 is a diagram of example components of one or more devices of FIG. 2, in accordance with some embodiments of the present disclosure.

FIG. 4 is a flowchart of an example process relating to federated log file searching, in accordance with some embodiments of the present disclosure.

### DETAILED DESCRIPTION

The following detailed description of example implementations refers to the accompanying drawings. The same reference numbers in different drawings may identify the same or similar elements.

In an enterprise system, log files may be generated by different platforms, infrastructure, applications, and software frameworks, and in different formats. For example, Splunk may capture log data in a proprietary format and store the log data in a separate storage from other log data. Searching across multiple platforms and formats for log files is computationally intensive.

Additionally, some systems that collate log files across platforms rely on a single, unified storage for collated log files. Accordingly, such systems consume large amounts of memory.

Some implementations described herein enable searching a set of standardized log files using a federated architecture. For example, an enterprise layer may store some of the standardized log files (e.g., for some applications) and an application layer may store others of the standardized log files (e.g., for other applications). As a result, memory usage is decreased as compared with memory usage by systems with a single, unified storage. Additionally, computational resources are conserved as compared with computational resources used by systems that search log files across multiple formats and multiple platforms.

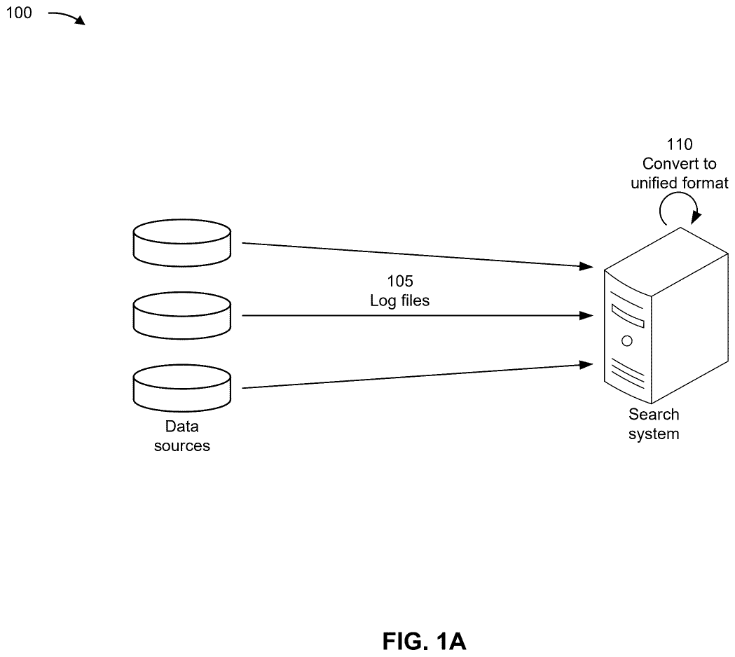

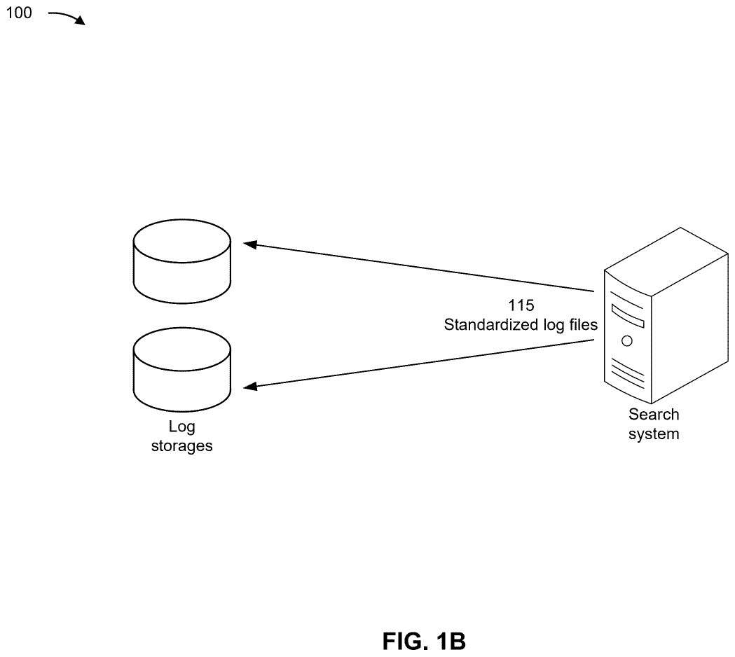

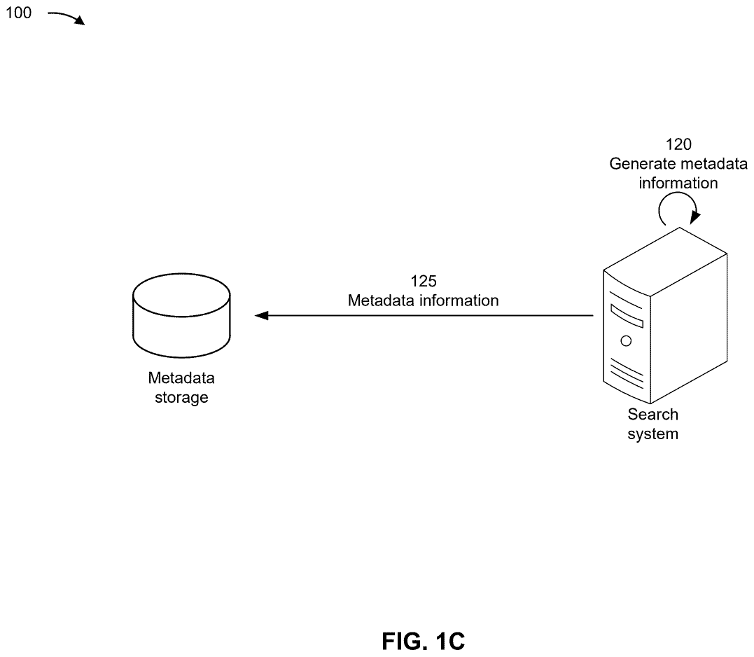

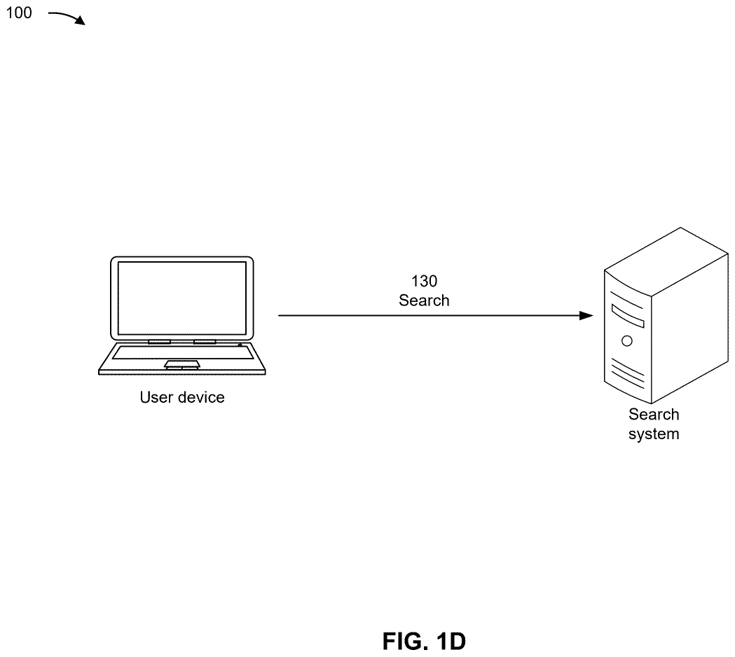

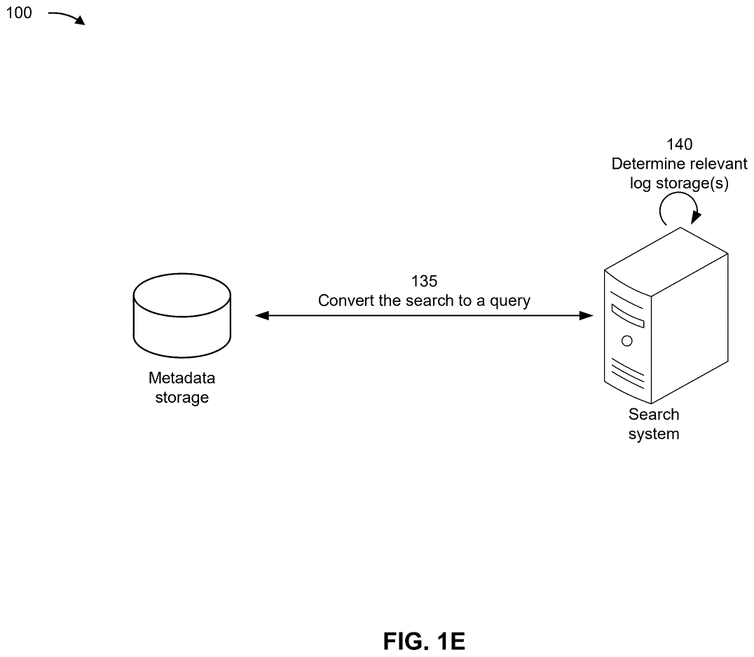

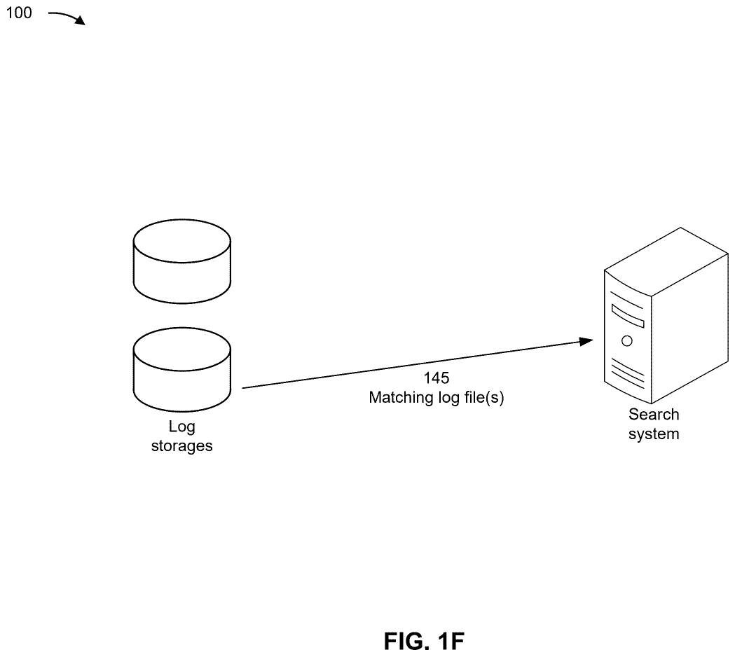

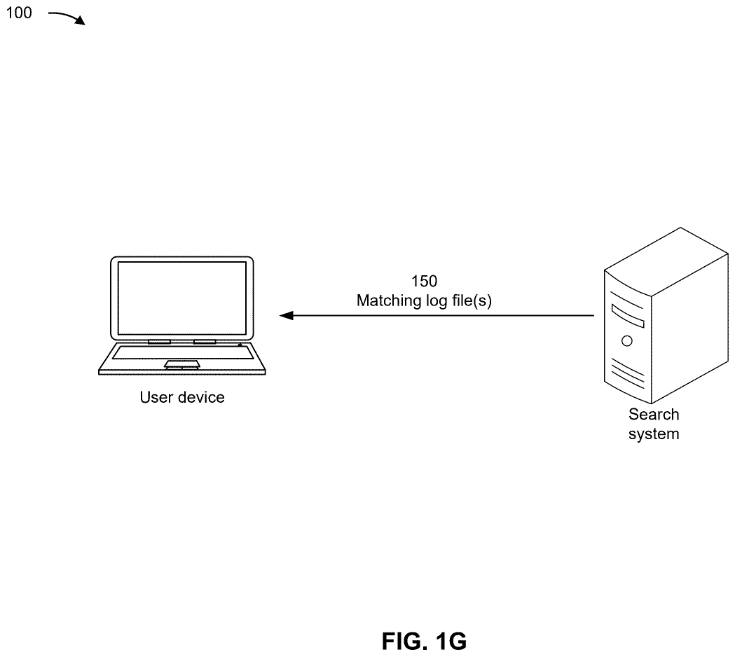

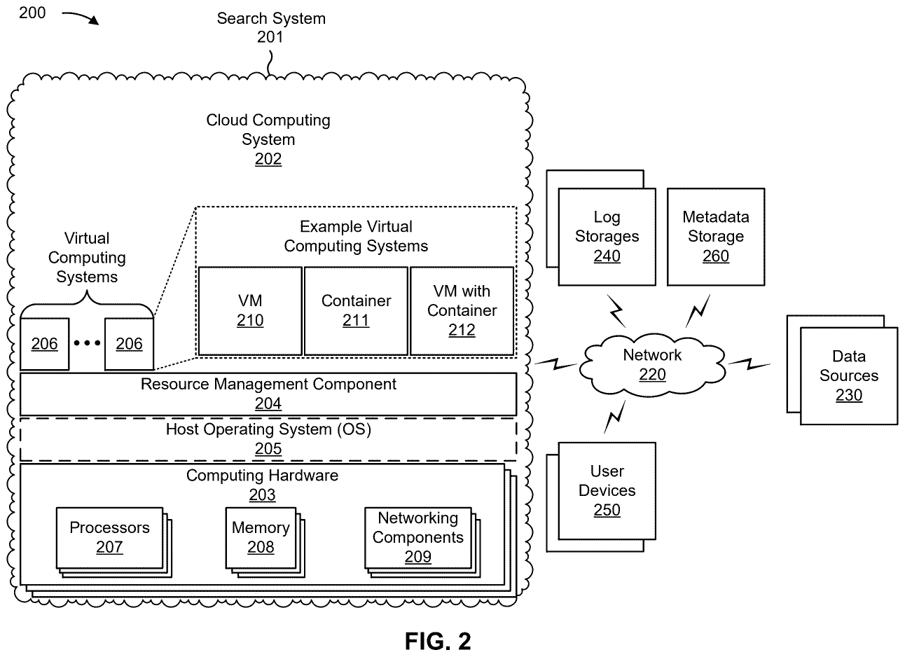

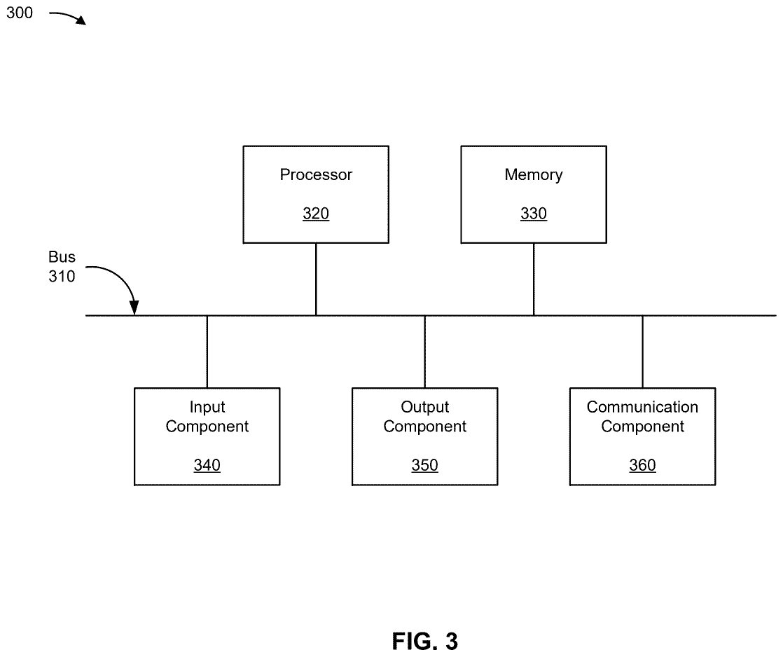

FIGS. 1A-1G are diagrams of an example 100 associated with a federated system for log file searching. As shown in FIGS. 1A-1G, example 100 includes a plurality of data sources, a search system, a plurality of log storages, a metadata storage, and a user device. These devices are described in more detail in connection with FIGS. 2 and 3.

As shown in FIG. 1A and by reference number 105, the plurality of data sources may transmit, and the search system may receive, a plurality of log files. Accordingly, the search system may collate the log files from multiple data sources. The plurality of log files may use at least two different formats. For example, each data source may store log files in a different format (whether a proprietary format or an open format, such as JavaScript® object notation (JSON), comma-separated values (CSV), or de-limited structured text, among other examples).

In one example, the search system may transmit a query, to each data source, that triggers the data source to transmit a portion of the log files, corresponding to the data source, to the search system. Accordingly, the search system may generate a set of queries, to transmit to the plurality of data sources, based on which data sources will be used for collating the plurality of log files. Each query may be (at least part of) an application programming interface (API) call, a hypertext transfer protocol (HTTP) request, and/or a file transfer protocol (FTP) request, among other examples.

In another example, the search system may subscribe to each data source (e.g., using an API call), such that each data source transmits new log files to the search system as the new log files become available (e.g., as created and stored on the data source).

In another example, the search system may obtain log files from the data sources using one or more data mining techniques. In some implementations, the search system may scrape log files by requesting (and then storing) webpages hosted by the data sources, where the webpages include information that is converted into log files by the search system. Additionally, or alternatively, the search system may screen record (or otherwise visually capture) information that is output graphically by the data sources, where the recorded information is converted into log files by the search system.

In some implementations, an administrator may provide input to the search system that triggers the search system to request the plurality of log files (or to subscribe to the plurality of data sources). The input may indicate the plurality of data sources (e.g., using machine names, Internet protocol (IP) addresses, and/or medium access control (MAC) addresses, among other examples).

As shown by reference number 110, the search system may convert the plurality of log files into a plurality of standardized log files. For example, for each log file, the search system may select a formula or algorithm (from a plurality of possible formulae or algorithms) based on a format of the log file, and the search system may use the formula or algorithm to convert the log file into a standardized log file. The plurality of standardized log files may use a unified format. For example, the unified format may be an open format (e.g., a format with publicly available technical specifications rather than propriety technical specifications). By using the unified format, the search system improves speed and accuracy of searches for particular log files.

As shown in FIG. 1B and by reference number 115, the search system may transmit, and the plurality of log storages may receive, the plurality of standardized log files. For example, the search system may transmit commands for the plurality of log storages to store the plurality of standardized log files. In some implementations, at least some of the log storages may be associated with (e.g., deployed at, whether physically, logically, and/or virtually) an enterprise layer of the search system. As used herein, “enterprise layer” may refer to a higher level of abstraction in a service-oriented architecture; accordingly, the enterprise layer may cross boundaries between domains of the search system. Additionally, others of the log storages may be associated with (e.g., deployed at, whether physically, logically, and/or virtually) an application layer of the search system. As used herein, “application layer” may refer to a lower level of abstraction in a service-oriented architecture; accordingly, the application layer may be encapsulated within a single domain of the search system. The enterprise layer thus has access to more of the standardized log files, while the application layer may execute searches faster.

As shown in FIG. 1C and by reference number 120, the search system may generate metadata information regarding the plurality of standardized log files. For example, the metadata information may indicate a quantity of standardized log files, applications that generated the log files, a quantity of log files per application, names associated with the log files, dates associated with creation of the log files, times associated with creation of the log files, keywords extracted from the standardized log files, and/or indications of which standardized log files are stored in which log stores, among other examples.

As shown by reference number 125, the search system may transmit, and the metadata storage may receive, the metadata information. For example, the search system may transmit a command for the metadata storage to store the metadata information. Therefore, the search system may use the metadata store to speed up searching and to convert human-readable searches into machine-readable queries, as described below in connection with FIG. 1E. The metadata storage may be associated with the application layer of the search system. Accordingly, the metadata storage may be duplicated across domains of the search system in order to increase speed of converting searches to queries.

As shown in FIG. 1D and by reference number 130, the user device may transmit, and the search system may receive, a search. For example, a user of the user device may instruct the user device to transmit the search in order to find a particular log file (or a particular set of log files). The user may provide input (e.g., by interacting with a user interface (UI) or by providing text-based input) that triggers the user device to transmit the search. The input may include terms and/or indicate filters that define the search.

In some implementations, the search may include an indication of selection of visual elements (e.g., one or more visual elements) by the user device. For example, the user of the user device may select a visual element that indicates a particular application to which the search should be limited. In another example, the user of the user device may select a visual element that indicates a range of dates and/or times to which the search should be limited. By providing for searching with visual elements, the search system improves the user's experience and speeds up searching.

As shown in FIG. 1E, the search system may convert the search into a query. For example, the search system may convert a human-readable search (whether input as text or as an indication of selected visual elements) into a machine-readable search (e.g., in structured query language (SQL) or another type of query language). As shown by reference number 135, the search system may use the metadata storage to convert the search into the query. For example, the metadata information may indicate names of tables and/or other data structures, in the plurality of log stores, such that the search system may generate the query to search through correct data structures.

Additionally, as shown by reference number 140, the search system may determine one or more relevant log storages (from the plurality of log storages) for the query. In some implementations, the search system may use the metadata storage to determine the relevant log storage(s). For example, the metadata information may indicate which applications (that generated log files) are associated with which log stores, such that the search system may generate the query to search the relevant log storage(s).

The search system may execute the query on the relevant log storage(s). Accordingly, as shown in FIG. 1F and by reference number 145, the search system may receive one or more matching log files from the relevant log storage(s). The search system may execute the query by performing an API call and/or by transmitting a request (e.g., an HTTP request and/or an FTP request, among other examples).

In some implementations, the search system may retrieve the matching log file(s), from the plurality of standardized log files, at the application layer. For example, the search system may determine that the relevant log storage(s) are associated with the application layer, and thus the search system may execute the query at the application layer. Additionally, or alternatively, the user device may be associated with the application layer (e.g., the user of the user device is authorized to perform searches at the application layer), and thus the search system may execute the query at the application layer. In some implementations, the plurality of standardized log files may be stored at the application layer (e.g., the relevant log storage(s) may be deployed at the application layer). Alternatively, an endpoint (e.g., one or more endpoints) for the relevant log storage(s) may be deployed at the application layer, even though the relevant log storage(s) are deployed at the enterprise layer. In both implementations, the matching log file(s) may be “retrieved” at the application layer.

In some implementations, the search system may retrieve the matching log file(s), from the plurality of standardized log files, at the enterprise layer. For example, the search system may determine that the relevant log storage(s) are associated with the enterprise layer, and thus the search system may execute the query at the enterprise layer. Additionally, or alternatively, the user device may be associated with the enterprise layer (e.g., the user of the user device is authorized to perform searches at the enterprise layer), and thus the search system may execute the query at the enterprise layer. In some implementations, the plurality of standardized log files may be stored at the enterprise layer (e.g., the relevant log storage(s) may be deployed at the enterprise layer). Additionally, or alternatively, an endpoint (e.g., one or more endpoints) for the relevant log storage(s) may be deployed at the enterprise layer. In both implementations, the matching log file(s) may be “retrieved” at the enterprise layer.

As shown in FIG. 1G, the search system may return the matching log file(s) to the user device, as shown by reference number 150. For example, the search system may return the matching log file(s) in response to the search from the user device. As described above, the search system may return the matching log file(s) from the application layer or the enterprise layer, depending on which layer executed the query (e.g., depending on which layer is associated with the relevant log store(s)).

By using techniques as described in connection with FIGS. 1A-1G, the search system provides for searching the plurality of standardized log files using a federated architecture. For example, the enterprise layer may store some of the standardized log files (e.g., for some applications), and the application layer may store others of the standardized log files (e.g., for other applications). As a result, memory usage is decreased as compared with memory usage by systems with a single, unified storage. Additionally, computational resources are conserved as compared with computational resources used by systems that search log files across multiple formats and multiple platforms.

Although the example 100 is described in connection with storage being managed either by the application layer or the enterprise layer, other examples may include federation of a processing engine and/or a search engine. For example, the client device may input the search to the application layer or to the enterprise layer. Additionally, or alternatively, the search may be converted to the query at the application layer or at the enterprise layer. Therefore, different operations described in connection with the example 100 may be performed by the application layer, the enterprise layer, or a combination thereof.

As indicated above, FIGS. 1A-1G are provided as an example. Other examples may differ from what is described with regard to FIGS. 1A-1G.

FIG. 2 is a diagram of an example environment 200 in which systems and/or methods described herein may be implemented. As shown in FIG. 2, environment 200 may include a search system 201, which may include one or more elements of and/or may execute within a cloud computing system 202. The cloud computing system 202 may include one or more elements 203-212, as described in more detail below. As further shown in FIG. 2, environment 200 may include a network 220, data sources 230, log storages 240, user devices 250, and/or a metadata storage 260. Devices and/or elements of environment 200 may interconnect via wired connections and/or wireless connections.

The cloud computing system 202 may include computing hardware 203, a resource management component 204, a host operating system (OS) 205, and/or one or more virtual computing systems 206. The cloud computing system 202 may execute on, for example, an Amazon Web Services platform, a Microsoft Azure platform, or a Snowflake platform. The resource management component 204 may perform virtualization (e.g., abstraction) of computing hardware 203 to create the one or more virtual computing systems 206. Using virtualization, the resource management component 204 enables a single computing device (e.g., a computer or a server) to operate like multiple computing devices, such as by creating multiple isolated virtual computing systems 206 from computing hardware 203 of the single computing device. In this way, computing hardware 203 can operate more efficiently, with lower power consumption, higher reliability, higher availability, higher utilization, greater flexibility, and lower cost than using separate computing devices.

The computing hardware 203 may include hardware and corresponding resources from one or more computing devices. For example, computing hardware 203 may include hardware from a single computing device (e.g., a single server) or from multiple computing devices (e.g., multiple servers), such as multiple computing devices in one or more data centers. As shown, computing hardware 203 may include one or more processors 207, one or more memories 208, and/or one or more networking components 209. Examples of a processor, a memory, and a networking component (e.g., a communication component) are described elsewhere herein.

The resource management component 204 may include a virtualization application (e.g., executing on hardware, such as computing hardware 203) capable of virtualizing computing hardware 203 to start, stop, and/or manage one or more virtual computing systems 206. For example, the resource management component 204 may include a hypervisor (e.g., a bare-metal or Type 1 hypervisor, a hosted or Type 2 hypervisor, or another type of hypervisor) or a virtual machine monitor, such as when the virtual computing systems 206 are virtual machines 210. Additionally, or alternatively, the resource management component 204 may include a container manager, such as when the virtual computing systems 206 are containers 211. In some implementations, the resource management component 204 executes within and/or in coordination with a host operating system 205.

A virtual computing system 206 may include a virtual environment that enables cloud-based execution of operations and/or processes described herein using computing hardware 203. As shown, a virtual computing system 206 may include a virtual machine 210, a container 211, or a hybrid environment 212 that includes a virtual machine and a container, among other examples. A virtual computing system 206 may execute one or more applications using a file system that includes binary files, software libraries, and/or other resources required to execute applications on a guest operating system (e.g., within the virtual computing system 206) or the host operating system 205.

Although the search system 201 may include one or more elements 203-212 of the cloud computing system 202, may execute within the cloud computing system 202, and/or may be hosted within the cloud computing system 202, in some implementations, the search system 201 may not be cloud-based (e.g., may be implemented outside of a cloud computing system) or may be partially cloud-based. For example, the search system 201 may include one or more devices that are not part of the cloud computing system 202, such as device 300 of FIG. 3, which may include a standalone server or another type of computing device. The search system 201 may perform one or more operations and/or processes described in more detail elsewhere herein.

The network 220 may include one or more wired and/or wireless networks. For example, the network 220 may include a cellular network, a public land mobile network (PLMN), a local area network (LAN), a wide area network (WAN), a private network, the Internet, and/or a combination of these or other types of networks. The network 220 enables communication among the devices of the environment 200.

The data sources 230 may include one or more devices capable of receiving, generating, storing, processing, and/or providing information associated with log files, as described elsewhere herein. The data sources 230 may include a communication device and/or a computing device. For example, the data sources 230 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The data sources 230 may communicate with one or more other devices of environment 200, as described elsewhere herein.

The log storages 240 may include one or more devices capable of receiving, generating, storing, processing, and/or providing information associated with standardized log files, as described elsewhere herein. The log storages 240 may include a communication device and/or a computing device. For example, the log storages 240 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The log storages 240 may communicate with one or more other devices of environment 200, as described elsewhere herein.

The user devices 250 may include one or more devices capable of receiving, generating, storing, processing, and/or providing information associated with searches, as described elsewhere herein. The user devices 250 may include a communication device and/or a computing device. For example, the user devices 250 may include a wireless communication device, a mobile phone, a user equipment, a laptop computer, a tablet computer, a desktop computer, a gaming console, a set-top box, a wearable communication device (e.g., a smart wristwatch, a pair of smart eyeglasses, a head mounted display, or a virtual reality headset), or a similar type of device. The user devices 250 may communicate with one or more other devices of environment 200, as described elsewhere herein.

The metadata storage 260 may include one or more devices capable of receiving, generating, storing, processing, and/or providing information associated with metadata, as described elsewhere herein. The metadata storage 260 may include a communication device and/or a computing device. For example, the metadata storage 260 may include a database, a server, a database server, an application server, a client server, a web server, a host server, a proxy server, a virtual server (e.g., executing on computing hardware), a server in a cloud computing system, a device that includes computing hardware used in a cloud computing environment, or a similar type of device. The metadata storage 260 may communicate with one or more other devices of environment 200, as described elsewhere herein.

The number and arrangement of devices and networks shown in FIG. 2 are provided as an example. In practice, there may be additional devices and/or networks, fewer devices and/or networks, different devices and/or networks, or differently arranged devices and/or networks than those shown in FIG. 2. Furthermore, two or more devices shown in FIG. 2 may be implemented within a single device, or a single device shown in FIG. 2 may be implemented as multiple, distributed devices. Additionally, or alternatively, a set of devices (e.g., one or more devices) of the environment 200 may perform one or more functions described as being performed by another set of devices of the environment 200.

FIG. 3 is a diagram of example components of a device 300 associated with federated system for log file searching. The device 300 may correspond to a data source 230, a log storage 240, a user device 250, and/or a metadata storage 260. In some implementations, a data source 230, a log storage 240, a user device 250, and/or a metadata storage 260 may include one or more devices 300 and/or one or more components of the device 300. As shown in FIG. 3, the device 300 may include a bus 310, a processor 320, a memory 330, an input component 340, an output component 350, and/or a communication component 360.

The bus 310 may include one or more components that enable wired and/or wireless communication among the components of the device 300. The bus 310 may couple together two or more components of FIG. 3, such as via operative coupling, communicative coupling, electronic coupling, and/or electric coupling. For example, the bus 310 may include an electrical connection (e.g., a wire, a trace, and/or a lead) and/or a wireless bus. The processor 320 may include a central processing unit, a graphics processing unit, a microprocessor, a controller, a microcontroller, a digital signal processor, a field-programmable gate array, an application-specific integrated circuit, and/or another type of processing component. The processor 320 may be implemented in hardware, firmware, or a combination of hardware and software. In some implementations, the processor 320 may include one or more processors capable of being programmed to perform one or more operations or processes described elsewhere herein.

The memory 330 may include volatile and/or nonvolatile memory. For example, the memory 330 may include random access memory (RAM), read only memory (ROM), a hard disk drive, and/or another type of memory (e.g., a flash memory, a magnetic memory, and/or an optical memory). The memory 330 may include internal memory (e.g., RAM, ROM, or a hard disk drive) and/or removable memory (e.g., removable via a universal serial bus connection). The memory 330 may be a non-transitory computer-readable medium. The memory 330 may store information, one or more instructions, and/or software (e.g., one or more software applications) related to the operation of the device 300. In some implementations, the memory 330 may include one or more memories that are coupled (e.g., communicatively coupled) to one or more processors (e.g., processor 320), such as via the bus 310. Communicative coupling between a processor 320 and a memory 330 may enable the processor 320 to read and/or process information stored in the memory 330 and/or to store information in the memory 330.

The input component 340 may enable the device 300 to receive input, such as user input and/or sensed input. For example, the input component 340 may include a touch screen, a keyboard, a keypad, a mouse, a button, a microphone, a switch, a sensor, a global positioning system sensor, a global navigation satellite system sensor, an accelerometer, a gyroscope, and/or an actuator. The output component 350 may enable the device 300 to provide output, such as via a display, a speaker, and/or a light-emitting diode. The communication component 360 may enable the device 300 to communicate with other devices via a wired connection and/or a wireless connection. For example, the communication component 360 may include a receiver, a transmitter, a transceiver, a modem, a network interface card, and/or an antenna.

The device 300 may perform one or more operations or processes described herein. For example, a non-transitory computer-readable medium (e.g., memory 330) may store a set of instructions (e.g., one or more instructions or code) for execution by the processor 320. The processor 320 may execute the set of instructions to perform one or more operations or processes described herein. In some implementations, execution of the set of instructions, by one or more processors 320, causes the one or more processors 320 and/or the device 300 to perform one or more operations or processes described herein. In some implementations, hardwired circuitry may be used instead of or in combination with the instructions to perform one or more operations or processes described herein. Additionally, or alternatively, the processor 320 may be configured to perform one or more operations or processes described herein. Thus, implementations described herein are not limited to any specific combination of hardware circuitry and software.

The number and arrangement of components shown in FIG. 3 are provided as an example. The device 300 may include additional components, fewer components, different components, or differently arranged components than those shown in FIG. 3. Additionally, or alternatively, a set of components (e.g., one or more components) of the device 300 may perform one or more functions described as being performed by another set of components of the device 300.

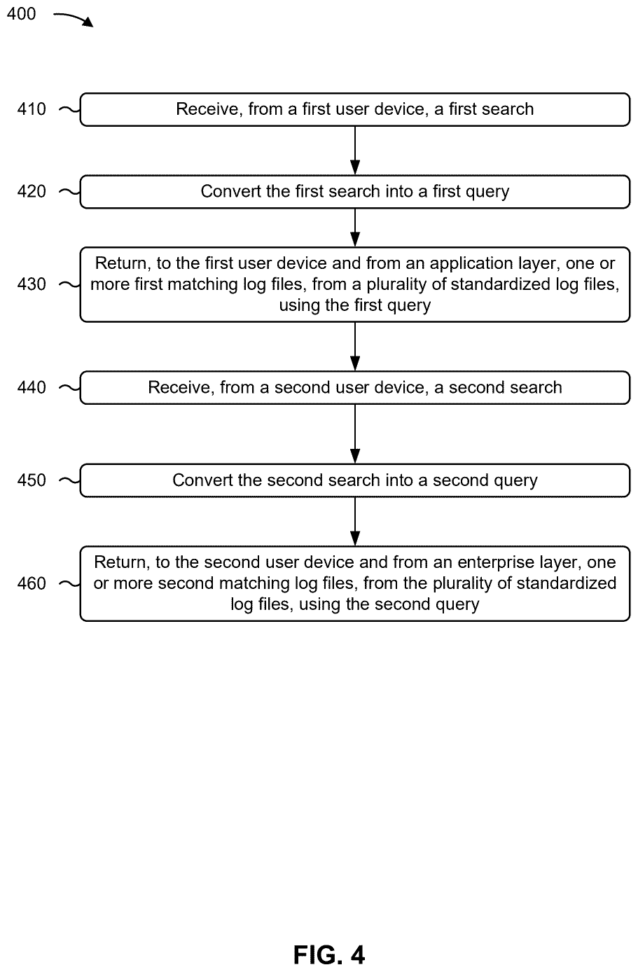

FIG. 4 is a flowchart of an example process 400 associated with federated log file searching. In some implementations, one or more process blocks of FIG. 4 may be performed by a search system 201. In some implementations, one or more process blocks of FIG. 4 may be performed by another device or a group of devices separate from or including the search system 201, such as a data source 230, a log storage 240, a user device 250, and/or a metadata storage 260. Additionally, or alternatively, one or more process blocks of FIG. 4 may be performed by one or more components of the device 300, such as processor 320, memory 330, input component 340, output component 350, and/or communication component 360.

As shown in FIG. 4, process 400 may include receiving, from a first user device, a first search (block 410). For example, the search system 201 (e.g., using processor 320, memory 330, and/or communication component 360) may receive, from a first user device, a first search, as described above in connection with reference number 130 of FIG. 1D. As an example, the first search may include an indication of selection of one or more visual elements by the first user device. For example, a first user of the first user device may select a visual element that indicates a particular application to which the first search should be limited. In another example, the first user of the first user device may select a visual element that indicates a range of dates and/or times to which the first search should be limited.

As further shown in FIG. 4, process 400 may include converting the first search into a first query (block 420). For example, the search system 201 (e.g., using processor 320, memory 330, and/or communication component 360) may convert the first search into a first query, as described above in connection with reference number 135 of FIG. 1E. As an example, the search system 201 may use a metadata storage to convert the first search into the first query. For example, metadata information in the metadata storage may indicate names of tables and/or other data structures, in a plurality of log stores, such that the search system 201 may generate the first query to search through correct data structures.

As further shown in FIG. 4, process 400 may include returning, to the first user device and from an application layer, one or more first matching log files, from a plurality of standardized log files, using the first query (block 430). For example, the search system 201 (e.g., using processor 320, memory 330, and/or communication component 360) may return, to the first user device and from an application layer, one or more first matching log files, from a plurality of standardized log files, using the first query, as described above in connection with reference number 150 of FIG. 1G. As an example, the application layer of the search system 201 may execute the first query (e.g., on one or more relevant log stores) in order to retrieve the one or more first matching log files.

As further shown in FIG. 4, process 400 may include receiving, from a second user device, a second search (block 440). For example, the search system 201 (e.g., using processor 320, memory 330, and/or communication component 360) may receive, from a second user device, a second search, as described above in connection with reference number 130 of FIG. 1D. As an example, the second search may include an indication of selection of one or more visual elements by the second user device. For example, a second user of the second user device may select a visual element that indicates a particular application to which the second search should be limited. In another example, the second user of the second user device may select a visual element that indicates a range of dates and/or times to which the second search should be limited.

As further shown in FIG. 4, process 400 may include converting the second search into a second query (block 450). For example, the search system 201 (e.g., using processor 320, memory 330, and/or communication component 360) may convert the second search into a second query, as described above in connection with reference number 135 of FIG. 1E. As an example, the search system 201 may use the metadata storage to convert the second search into the second query. For example, the metadata information in the metadata storage may indicate names of tables and/or other data structures, in the plurality of log stores, such that the search system 201 may generate the second query to search through correct data structures.

As further shown in FIG. 4, process 400 may include returning, to the second user device and from an enterprise layer, one or more second matching log files, from the plurality of standardized log files, using the second query (block 460). For example, the search system 201 (e.g., using processor 320, memory 330, and/or communication component 360) may return, to the second user device and from an enterprise layer, one or more second matching log files, from the plurality of standardized log files, using the second query, as described above in connection with reference number 150 of FIG. 1G. As an example, the enterprise layer of the search system 201 may execute the second query (e.g., on one or more relevant log stores) in order to retrieve the one or more second matching log files.

Although FIG. 4 shows example blocks of process 400, in some implementations, process 400 may include additional blocks, fewer blocks, different blocks, or differently arranged blocks than those depicted in FIG. 4. Additionally, or alternatively, two or more of the blocks of process 400 may be performed in parallel. The process 400 is an example of one process that may be performed by one or more devices described herein. These one or more devices may perform one or more other processes based on operations described herein, such as the operations described in connection with FIGS. 1A-1G. Moreover, while the process 400 has been described in relation to the devices and components of the preceding figures, the process 400 can be performed using alternative, additional, or fewer devices and/or components. Thus, the process 400 is not limited to being performed with the example devices, components, hardware, and software explicitly enumerated in the preceding figures.

The foregoing disclosure provides illustration and description, but is not intended to be exhaustive or to limit the implementations to the precise forms disclosed. Modifications may be made in light of the above disclosure or may be acquired from practice of the implementations.

As used herein, the term “component” is intended to be broadly construed as hardware, firmware, or a combination of hardware and software. It will be apparent that systems and/or methods described herein may be implemented in different forms of hardware, firmware, and/or a combination of hardware and software. The hardware and/or software code described herein for implementing aspects of the disclosure should not be construed as limiting the scope of the disclosure. Thus, the operation and behavior of the systems and/or methods are described herein without reference to specific software code-it being understood that software and hardware can be used to implement the systems and/or methods based on the description herein.

As used herein, satisfying a threshold may, depending on the context, refer to a value being greater than the threshold, greater than or equal to the threshold, less than the threshold, less than or equal to the threshold, equal to the threshold, not equal to the threshold, or the like.

Although particular combinations of features are recited in the claims and/or disclosed in the specification, these combinations are not intended to limit the disclosure of various implementations. In fact, many of these features may be combined in ways not specifically recited in the claims and/or disclosed in the specification. Although each dependent claim listed below may directly depend on only one claim, the disclosure of various implementations includes each dependent claim in combination with every other claim in the claim set. As used herein, a phrase referring to “at least one of” a list of items refers to any combination and permutation of those items, including single members. As an example, “at least one of: a, b, or c” is intended to cover a, b, c, a-b, a-c, b-c, and a-b-c, as well as any combination with multiple of the same item. As used herein, the term “and/or” used to connect items in a list refers to any combination and any permutation of those items, including single members (e.g., an individual item in the list). As an example, “a, b, and/or c” is intended to cover a, b, c, a-b, a-c, b-c, and a-b-c.

When “a processor” or “one or more processors” (or another device or component, such as “a controller” or “one or more controllers”) is described or claimed (within a single claim or across multiple claims) as performing multiple operations or being configured to perform multiple operations, this language is intended to broadly cover a variety of processor architectures and environments. For example, unless explicitly claimed otherwise (e.g., via the use of “first processor” and “second processor” or other language that differentiates processors in the claims), this language is intended to cover a single processor performing or being configured to perform all of the operations, a group of processors collectively performing or being configured to perform all of the operations, a first processor performing or being configured to perform a first operation and a second processor performing or being configured to perform a second operation, or any combination of processors performing or being configured to perform the operations. For example, when a claim has the form “one or more processors configured to: perform X; perform Y; and perform Z,” that claim should be interpreted to mean “one or more processors configured to perform X; one or more (possibly different) processors configured to perform Y; and one or more (also possibly different) processors configured to perform Z.” No element, act, or instruction used herein should be construed as critical or essential unless explicitly described as such. Also, as used herein, the articles “a” and “an” are intended to include one or more items, and may be used interchangeably with “one or more.” Further, as used herein, the article “the” is intended to include one or more items referenced in connection with the article “the” and may be used interchangeably with “the one or more.” Furthermore, as used herein, the term “set” is intended to include one or more items (e.g., related items, unrelated items, or a combination of related and unrelated items), and may be used interchangeably with “one or more.” Where only one item is intended, the phrase “only one” or similar language is used. Also, as used herein, the terms “has,” “have,” “having,” or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A system for providing federated searching, the system comprising:
one or more memories; and
one or more processors, communicatively coupled to the one or more memories, configured to:
receive, from a plurality of data sources, a plurality of log files, wherein the plurality of log files use at least two different formats;
store, after converting the plurality of log files into a plurality of standardized log files, the plurality of standardized log files, wherein the plurality of standardized log files use a unified format;
receive a first search;
retrieve, at an application layer and based on determining that one or more log storages that are relevant to the first search are associated with the application layer, one or more first matching log files, from the plurality of standardized log files;
receive a second search; and retrieve, at an enterprise layer and based on determining that one or more log storages that are relevant to the second search are associated with the enterprise layer, one or more second matching log files, from the plurality of standardized log files,

2. The system of claim 1, wherein the unified format comprises an open format.

3. The system of claim 1, wherein the one or more processors are further configured to:
determine, using a metadata storage, the one or more log storages that are relevant to the first search, from a plurality of log storages including the plurality of standardized log files; and
generate a first query, from the first search, to execute on the one or more log storages that are relevant to the first search.

4. The system of claim 3, wherein the metadata storage is associated with the application layer.

5. The system of claim 1, wherein the one or more processors are further configured to:
determine, using a metadata storage, the one or more log storages that are relevant to the second search, from a plurality of log storages including the plurality of standardized log files; and
generate a second query, from the second search, to execute on the one or more log storages that are relevant to the second search.

6. The system of claim 1, wherein the first search comprises an indication of a selection of one or more visual elements by a first user device.

7. The system of claim 1, wherein the second search comprises an indication of a selection of one or more visual elements by a second user device.

8. A method of providing federated searching of a plurality of standardized log files, comprising:
receiving, from a first user device and at a search system, a first search;
returning, to the first user device, [[and ]]from an application layer of the search system, and based on determining that one or more storages that are relevant to the first search are associated with the application layer, one or more first matching log files, from the plurality of standardized log files;
receiving, from a second user device and at the search system, a second search and
returning, to the second user device, from an enterprise layer of the search system, and based on determining that one or more storages that are relevant to the second search are associated with the enterprise layer, one or more second matching log files, from the plurality of standardized log files.

9. The method of claim 8, wherein receiving the first search comprises:
receiving an indication of a selection of one or more visual elements by the first user device,
wherein the indication defines the first search.

10. The method of claim 8, wherein receiving the second search comprises:
receiving an indication of a selection of one or more visual elements by the second user device,
wherein the indication defines the second search.

11. The method of claim 8, wherein the plurality of standardized log files are stored across a plurality of log storages.

12. The method of claim 11, further comprising:
retrieving the one or more first matching log files from the one or more storages that are relevant to the first search.

13. The method of claim 8, wherein the plurality of standardized log files use an open format.

14. A non-transitory computer-readable medium storing a set of instructions for providing federated searching of a plurality of standardized log files, the set of instructions comprising:
one or more instructions that, when executed by one or more processors of a device, cause the device to:
receive a first search;
determine, using a metadata storage associated with the plurality of standardized log files, one or more log storages that are relevant to the first search;
retrieve, at an application layer and based on determining that the one or more log storages that are relevant to the first search are associated with the application layer, one or more first matching log files, from the plurality of standardized log files;
receive a second search;
determine, using the metadata storage, one or more log storages that are relevant to the second search; and
retrieve, at an enterprise layer and based on determining that the one or more log storages that are relevant to the second search are associated with the enterprise layer, one or more second matching log files, from the plurality of standardized log files.

15. The non-transitory computer-readable medium of claim 14, wherein the one or more instructions, when executed by the one or more processors, cause the device to:
convert a plurality of log files into the plurality of standardized log files.

16. The non-transitory computer-readable medium of claim 15, wherein the one or more instructions, when executed by the one or more processors, cause the device to:
generate metadata information from the plurality of log files; and
transmit the metadata information to the metadata storage.

17. The non-transitory computer-readable medium of claim 14, wherein the one or more instructions, when executed by the one or more processors, cause the device to:
output the one or more first matching log files to a first user device.

18. The non-transitory computer-readable medium of claim 17, wherein the one or more instructions, when executed by the one or more processors, cause the device to:
output the one or more second matching log files to a second user device.

19. The non-transitory computer-readable medium of claim 14, wherein the metadata storage is associated with the application layer.

20. The non-transitory computer-readable medium of claim 14, wherein the plurality of standardized log files use an open format.
